(19) United States
(12) Patent Application Publication
(10) Pub. No.: US 2026/0187399 A1
(43) Pub. Date: Jul. 2, 2026

(54) METHOD OF CREATING PROOF IMAGE DATA, PROOF IMAGE GENERATION DEVICE, AND NON-TRANSITORY COMPUTER-READABLE STORAGE MEDIUM STORING PROGRAM

(71) Applicant: SEIKO EPSON CORPORATION, TOKYO (JP)

(72) Inventors: Takahiro KAMADA, MATSUMOTO-SHI (JP); Yuko YAMAMOTO, SHIOJIRI-SHI (JP); Takuya ONO, SHIOJIRI-SHI (JP); Mitsuhiro YAMASHITA, MATSUMOTO-SHI (JP)

(21) Appl. No.: 19/432,973

(22) Filed: Dec. 25, 2025

(30) Foreign Application Priority Data
Dec. 26, 2024 (JP) 2024-229787

(51) Int. Cl. G06K 15/02; B41J 3/407; B41J 3/44; D06P 7/00; G06T 7/40; G06T 11/10

(52) U.S. Cl. CPC G06K 15/1872; B41J 3/4078; B41J 3/44; D06P 7/005; G06K 15/021; G06K 15/1868; G06T 7/40; G06T 11/10; G06T 2207/10024

(57) ABSTRACT

A method of creating proof image data includes acquiring basic proof image data for reproducing, by a proof output device, a color distribution of a basic printed matter formed by applying a basic backing to a print fabric obtained by printing an image on a fabric using a printing machine, acquiring four types of texture information based on four types of texture images, acquiring evenness of dye characteristic information indicating evenness of dye of ink in a fabric for texture acquisition using the four types of texture information, acquiring transmission characteristic information indicating a degree of light transmission of the fabric for texture acquisition using the four types of texture information, and creating texture-added proof image data by applying texture addition processing using the evenness of dye characteristic information and the transmission characteristic information to the basic proof image data.

The present application is based on, and claims priority from JP Application Serial Number 2024-229787, filed Dec. 26, 2024, the disclosure of which is hereby incorporated by reference herein in its entirety.

### BACKGROUND

### 1. Technical Field

The present disclosure relates to a method of creating proof image data, a proof image generation device, and a non-transitory computer-readable storage medium storing a program.

### 2. Related Art

JP-A-09-270930 describes a technique related to creation of a print proof. In this technique, for each type of printing paper, a paper texture template is created based on the density distribution of the surface of a printed matter on which printing is executed with the halftone dot area ratio data as 100%. The paper texture template is used as a template for correcting a sense of texture according to the type of printing paper.

JP-A-09-270930 is an example of the related art.

In the technique described in JP-A-09-270930, “unevenness” and “roughness” of the texture of the paper can be expressed, but no consideration is given to the addition of the texture with respect to a medium through which the background is seen. Therefore, there is room for further improvement in the technique of adding texture to a medium through which the background is seen in a proof image.

### SUMMARY

The present disclosure can be implemented according to the aspects given below.

According to a first aspect of the present disclosure, a method of creating proof image data is provided. The method of creating proof image data includes (a) acquiring basic proof image data for reproducing, by a proof output device, a color distribution of a basic printed matter formed by applying a basic backing to a print fabric obtained by printing an image on a fabric using a printing machine, (b) acquiring four types of texture information based on four types of texture images including (i) an image obtained by imaging a non-print area with no image printed thereon using ink of a fabric for texture acquisition with a first backing as a background, (ii) an image obtained by imaging the non-print area of the fabric for texture acquisition with a second backing having a color different from the first backing as a background, (iii) an image obtained by imaging a print area with an image printed thereon using the ink of the fabric for texture acquisition with the first backing as a background, and (iv) an image obtained by imaging the print area of the fabric for texture acquisition with the second backing as a background, (c) acquiring evenness of dye characteristic information indicating evenness of dye of the ink in the fabric for texture acquisition using the four types of texture information, (d) acquiring transmission characteristic information indicating a degree of light transmission of the fabric for texture acquisition using the four types of texture information, and (e) creating texture-added proof image data by applying texture addition processing using the evenness of dye characteristic information and the transmission characteristic information to the basic proof image data.

According to a second aspect of the present disclosure, a proof image generation device is provided. The proof image generation device includes a basic proof image acquisition unit that acquires basic proof image data for reproducing, by a proof output device, a color distribution of a basic printed matter formed by applying a basic backing to a print fabric obtained by printing an image on a fabric using a printing machine, a texture information acquisition unit that acquires four types of texture information based on four types of texture images including (i) an image obtained by imaging a non-print area with no image printed thereon using ink of a fabric for texture acquisition with a first backing as a background, (ii) an image obtained by imaging the non-print area of the fabric for texture acquisition with a second backing having a color different from the first backing as a background, (iii) an image obtained by imaging a print area with an image printed thereon using the ink of the fabric for texture acquisition with the first backing as a background, and (iv) an image obtained by imaging the print area of the fabric for texture acquisition with the second backing as a background, an evenness of dye characteristic acquisition unit that acquires evenness of dye characteristic information indicating evenness of dye of the ink in the fabric for texture acquisition using the four types of texture information, a transmission characteristic acquisition unit that acquires transmission characteristic information indicating a degree of light transmission of the fabric for texture acquisition using the four types of texture information, and a texture-added proof image data creation unit that creates texture-added proof image data by applying texture addition processing using the evenness of dye characteristic information and the transmission characteristic information to the basic proof image data.

According to a third aspect of the present disclosure, a non-transitory computer-readable storage medium storing a program is provided. The program is a program for creating texture-added proof image data causing a computer to implement a function of acquiring basic proof image data for reproducing, by a proof output device, a color distribution of a basic printed matter formed by applying a basic backing to a print fabric obtained by printing an image on a fabric using a printing machine, a function of acquiring four types of texture information based on four types of texture images including (i) an image obtained by imaging a non-print area with no image printed thereon using ink of a fabric for texture acquisition with a first backing as a background, (ii) an image obtained by imaging the non-print area of the fabric for texture acquisition with a second backing having a color different from the first backing as a background, (iii) an image obtained by imaging a print area with an image printed thereon using the ink of the fabric for texture acquisition with the first backing as a background, and (iv) an image obtained by imaging the print area of the fabric for texture acquisition with the second backing as a background, a function of acquiring evenness of dye characteristic information indicating evenness of dye of the ink in the fabric for texture acquisition using the four types of texture information, a function of acquiring transmission characteristic information indicating a degree of light transmission of the fabric for texture acquisition using the four types of texture information, and a function of creating texture-added proof image data by applying texture addition processing using the evenness of dye characteristic information and the transmission characteristic information to the basic proof image data.

### BRIEF DESCRIPTION OF THE DRAWINGS

FIG. 1 shows a printing system for proofreading a printed matter.

FIG. 2 is a block diagram showing a configuration of a proof image data creation device.

FIG. 3 shows a flow of proof image creation processing.

FIG. 4 shows an example of texture values as texture information.

FIG. 5 is a flowchart showing a procedure of creation processing of proof image data.

FIG. 6 shows an example of a window used for acquiring backing color information.

FIG. 7 is a flowchart showing a detailed procedure of step S40 in FIG. 5.

FIG. 8 shows examples of a print fabric to which different backings are applied.

FIG. 9 is a top view and cross-sectional views of an example of a fabric.

FIG. 10 is a graph showing an example of a background reference rate determination curve.

FIG. 11 shows an example of measurement results of distributions of lightness constituting texture values in maps.

FIG. 12 is a graph showing an example of an adjustment coefficient determination curve.

### DESCRIPTION OF EMBODIMENTS

### A. First Embodiment

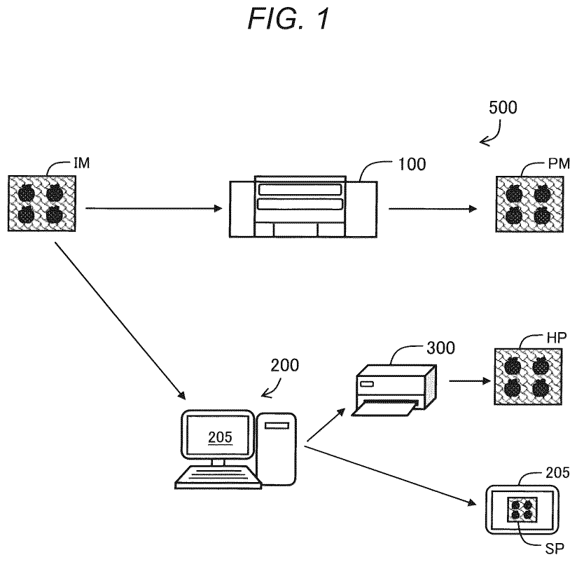

FIG. 1 shows a printing system 500 for proofreading a printed matter. The printing system 500 includes a printing machine 100 that prints a printed matter PM according to input image data IM, a proof image data creation device 200 that creates proof image data using the input image data IM, and a proofreading printing device 300 that prints a proof according to the proof image data.

The printing machine 100 is, for example, a textile printing machine that creates a print fabric by performing textile printing on a fabric print medium. In the present embodiment, printed matters in which images are printed on the following four types of fabrics are assumed. Since the fabric is used as a print medium, the fabric having low evenness of dye of ink is not assumed.

(T1) Non-transmissive dyeing even type: a fabric having a property of not transmitting light due to small gaps between threads of the fabric and having high evenness of dye. In the present specification, the evenness of dye indicates the degree of evenness of dyeing with ink. Higher evenness of dye refers to higher evenness of dyeing with ink. For example, the fabric is a polyester fabric.

(T2) Transmissive dyeing even type: a fabric having a property of transmitting light due to large gaps between threads of the fabric and having high evenness of dye. For example, the fabric includes chiffon, organdy, and georgette.

(T3) Non-transmissive dyeing uneven type: a fabric having a property of not transmitting light due to small gaps between threads of the fabric and not having high evenness of dye. For example, the fabric is felt. Examples of the felt include woven felt and compressed felt. In the case of the compressed felt, light is not transmitted because the gaps between the fibers constituting the fabric are small, but a texture can be added to the proof image data similarly to the woven felt.

(T4) Transmissive dyeing uneven type: a fabric having a property of transmitting light due to large gaps between threads of the fabric and not having high evenness of dye. For example, the fabric is a woven fabric using a thread for knitting whose main raw material is natural hair.

Proofreading includes hard proof of printing a proof print HP using the proofreading printing device 300 and soft proof of displaying a proof image SP on a display device 205 according to the proof image data. In the hard proof, the proofreading printing device 300 corresponds to a “proof output device”, and in the soft proof, the display device 205 corresponds to a “proof output device”. The image output from the proof output device is also referred to as an “output image”. The proof print HP corresponds to the “output image” in the hard proof, and the proof image SP corresponds to the “output image” in the soft proof.

The proof image data creation device 200 is configured to execute at least one of the hard proof and the soft proof. In the hard proof, the proofreading printing device 300 prints the proof print HP according to the proof image data created by the proof image data creation device 200. When the proofreading printing device 300 is an inkjet printer, the proof image data creation device 200 creates dot data for printing by applying color conversion processing or halftone processing to the proof image data, and supplies the dot data to the proofreading printing device 300 to execute printing of the proof print HP. In the soft proof, the proof image SP is displayed on the display device 205 according to the proof image data created by the proof image data creation device 200. The present disclosure is applicable to both the hard proof and the soft proof. In the present embodiment, the proof image data finally output by the proof image data creation device 200 represents an image in which the texture of the print medium is reproduced.

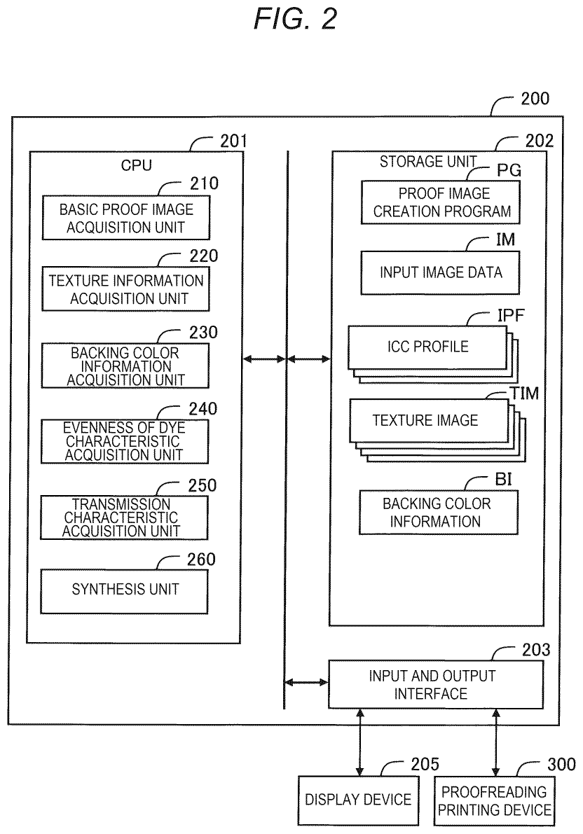

FIG. 2 is a block diagram showing a configuration of the proof image data creation device 200. The proof image data creation device 200 is a computer including a CPU (Central Processing Unit) 201 as a processor, a storage unit 202, an input and output interface 203, and the display device 205. The CPU 201, the storage unit 202, and the input and output interface 203 are coupled to one another via an internal bus so as to be capable of bidirectional communication.

The CPU 201 functions as a basic proof image acquisition unit 210, a texture information acquisition unit 220, a backing color information acquisition unit 230, an evenness of dye characteristic acquisition unit 240, a transmission characteristic acquisition unit 250, and a synthesis unit 260 by executing a proof image creation program PG stored in advance in the storage unit 202. At least part of the functions of these units 210 to 260 may be implemented by a hardware circuit or may be implemented on a cloud.

The input and output interface 203 is coupled to the display device 205 and the proofreading printing device 300 in a wired or wireless manner. The display device 205 is used to display an input window and a proof image described later.

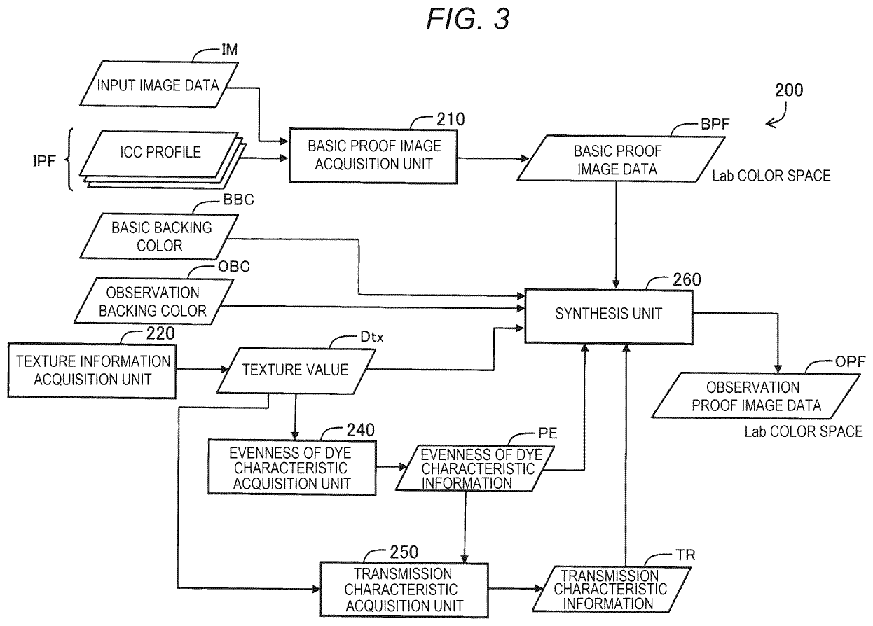

FIG. 3 shows a flow of proof image creation processing. The basic proof image acquisition unit 210 acquires basic proof image data BPF. The basic proof image data BPF is data in which a difference in color reproduction between the printing machine 100 and the proof output device is reflected on the input image data IM. In other words, the basic proof image data BPF is data for reproducing, by the proof output device, the distribution of the colors printed on the print medium using the printing machine 100. The texture of the fabric as the print medium is not reflected on the basic proof image data BPF. The basic proof image data BPF is used for reproducing the color of the basic printed matter obtained by applying a basic backing to the print fabric by the proof output device.

The “backing” refers to a backing material for the print fabric. For example, the basic backing is used for creating a media profile of the printing machine 100 regarding the fabric. Specifically, first, a plurality of solid color images are printed on the fabric using the printing machine 100 to create a plurality of color patches. Then, color measurement is performed in a state where the basic backing is applied to the color patches, and a media profile of the printing machine 100 regarding the fabric is created using the color measurement result. The basic backing may be referred to as a “backing for color measurement”.

In the present embodiment, the basic proof image acquisition unit 210 creates the basic proof image data BPF from the input image data IM. In the creation processing, for example, various ICC profiles IPF such as an input profile of the input image data IM, a device profile and a media profile of the proof output device, and the media profile of the printing machine 100 are used. However, when the basic proof image data BPF is already created, the basic proof image acquisition unit 210 may acquire the basic proof image data BPF by reading the data from the storage unit 202.

Any method can be used as a method of creating the basic proof image data BPF. For example, a method described in JP-A-2024-81234 disclosed by the applicant of the present disclosure may be used. In this method, the following processing is sequentially executed.

### Processing P1

First image data is acquired by converting the color space of the input image data IM into the output color space of the printing machine 100 using the ICC profile IPF.

### Processing P2

Second image data expressed in an absolute XYZ color space is acquired by performing, on the first image data, conversion using a first conversion table into representation in a profile connection space and white point conversion using information on an appearance in a predetermined observation environment of a ground color portion with no image in the printed matter PM.

### Processing P3

The second image data is converted into converted image data expressed in the output color space of the proof output device by using a second conversion table. The output color space of the proof output device is, for example, a CMYK color space or an RGB color space.

The proof image may be created by using the method described in the related art (JP-A-09-270930) or JP-A-2006-30277. When the method in JP-A-09-270930 is used, the basic proof image data BPF in which the texture is not reflected can be created by executing processing in which the first correction and the second correction related to a texture of paper are omitted.

In the first embodiment, the basic proof image data BPF is expressed in an L*a*b* color space. However, the data may be expressed by another device-independent color space such as an XYZ color space. When the basic proof image data expressed in the output color space of the proof output device is created using the above-described various methods, the output color space can be converted into the L*a*b* color space using an output profile of the proof output device. When the method described in JP-A-2024-81234 is used, the basic proof image data BPF may be created by converting the second image data expressed in the absolute XYZ color space into the L*a*b* color space. In the following description, L*a*b* is simply referred to as “Lab”.

The texture information acquisition unit 220 illustrated in FIG. 3 acquires texture information using a texture image TIM prepared in advance. The texture image TIM is an image obtained by imaging a fabric for texture acquisition with a backing as a background. The texture information is used in synthesis processing of adding a texture to the basic proof image data BPF.

In the present embodiment, the texture image TIM obtained by imaging each of the four types of (T1) to (T4) as the fabric for texture acquisition is prepared in advance and stored in the storage unit 202. The texture image TIM is an image obtained by imaging the fabric for texture acquisition with a first backing Back1 or a second backing Back2 as a background. The first backing Back1 is white, and the second backing Back2 is black. The color of the fabric for texture acquisition is white. For example, the measurement values obtained by measuring the L* value, a*, and b* of the fabric for texture acquisition under the standard light source are stored in the storage unit 202 in advance. The fabric for texture acquisition of each of (T1) to (T4) includes a print area PR and a non-print area NR. The print area PR is an area of the fabric for texture acquisition in which a solid color image is printed in black in the device-dependent color space by textile printing. The non-print area NR is an area where no image is printed in the fabric for texture acquisition. In the setting of printing for forming the print area PR on the fabric for texture acquisition, it is desirable that the Duty value of the ink is set to a predetermined reference value or more. The Duty value of the ink indicates the amount of the ink per unit area ejected onto the medium. By forming the print area PR by printing with the increased Duty value of the ink, it is possible to acquire the texture image TIM in which the difference in lightness is clear in the comparison between the print area PR and the non-print area NR.

For each of the four types of (T1) to (T4), the following four texture images TIM are obtained by combinations of the print area PR and non-print area NR and the first backing and second backing:
(i) a texture image TIM1 obtained by imaging the non-print area NR of the fabric for texture acquisition superimposed on the first backing Back1;
(ii) a texture image TIM2 obtained by imaging the non-print area NR of the fabric for texture acquisition superimposed on the second backing Back2;
(iii) a texture image TIM3 obtained by imaging the print area PR of the fabric for texture acquisition superimposed on the first backing Back1; and
(iv) a texture image TIM4 obtained by imaging the print area PR of the fabric for texture acquisition superimposed on the second backing Back2.

The texture images TIM1 to TIM4 are expressed in the Lab color space. The texture information acquisition unit 220 reads the texture image from the storage unit 202 and acquires texture information based on the texture image. The texture information is used to express the unevenness of the fabric. The texture information acquisition unit 220 acquires texture information TI based on the texture image TIM1. The texture information acquisition unit 220 similarly acquires texture values Dtx based on the respective texture images TIM2 to TIM4. The texture image TIM1 is also referred to as a “first texture image”. The texture image TIM2 is also referred to as a “second texture image”. The texture image TIM3 is also referred to as a “third texture image”. The texture image TIM4 is also referred to as a “fourth texture image”. In the present embodiment, the texture information TI includes at least a texture value for each pixel. When the print medium is of (T2) the transmissive dyeing even type or (T4) the transmissive dyeing uneven type, the texture information TI further includes transmission characteristic information to be described later.

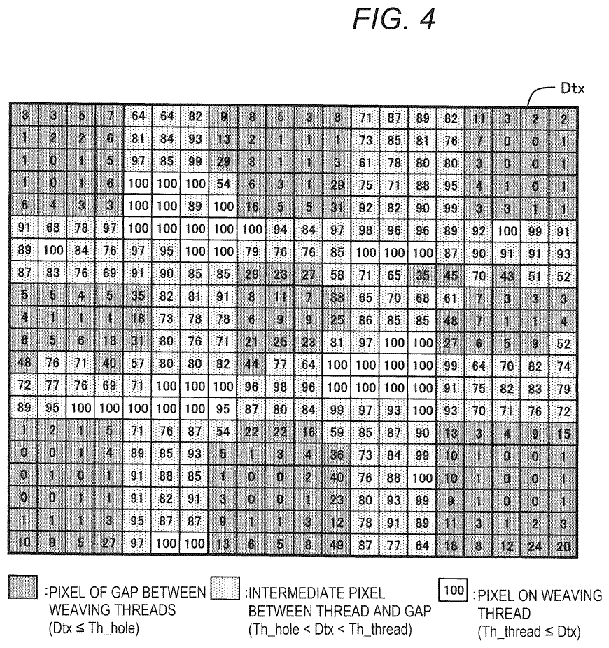

FIG. 4 shows an example of the texture values Dtx as the texture information TI. The texture values Dtx are formed as a map representing the lightness of the print medium. In the example of FIG. 4, the lightness takes a value in a range from 0 (black) to 100 (white).

The texture information acquisition unit 220 creates a lightness map in which the lightness of each pixel of the texture image TIM1 is associated with the coordinates of the pixel as the texture values Dtx. The texture information acquisition unit 220 similarly creates a lightness map as the texture values Dtx for the texture images TIM2 to TIM4. Each texture value Dtx based on the texture images TIM1 to TIM4 is used for acquisition processing of evenness of dye characteristic information of the evenness of dye characteristic acquisition unit 240 and acquisition processing of transmission characteristic information of the transmission characteristic acquisition unit 250 described later. Hereinafter, the texture value Dtx based on the texture image TIM1 may be referred to as a first texture value Dtx1, the texture value Dtx based on the texture image TIM2 may be referred to as a second texture value Dtx2, the texture value Dtx based on the texture image TIM3 may be referred to as a third texture value Dtx3, and the texture value Dtx based on the texture image TIM4 may be referred to as a fourth texture value Dtx4. The first texture value Dtx1 is also referred to as a “first lightness map”. The second texture value Dtx2 is also referred to as a “second lightness map”. The third texture value Dtx3 is also referred to as a “third lightness map”. The fourth texture value Dtx4 is also referred to as a “fourth lightness map”.

The evenness of dye characteristic acquisition unit 240 illustrated in FIG. 3 acquires evenness of dye characteristic information PE representing evenness of dye of the ink in the fabric.

In the present embodiment, the evenness of dye of the ink represents the degree of color dyeing depending on the amount of fluff. In textile printing by a textile printing machine, ink droplets are ejected onto fabric. In a case of a fabric with fluff such as felt, the ink tends to be difficult to land on the fluff. In this case, uneven dyeing occurs due to the presence of the undyed fluff, resulting in uneven dyeing. Or, in a case of a fabric with fluff in a large thickness such as a woven fabric using a thread for knitting, the ink tends to be difficult to land on the fluff. Also in this case, uneven dyeing occurs due to the presence of the undyed fluff, resulting in uneven dyeing. Furthermore, in the case of the fabric with fluff in the large thickness such as a woven fabric using a thread for knitting, even though the ink lands on the fluff, dyeing may appear to be uneven because the fabric has the fluff and the large thickness. As described above, even when the ink droplets are evenly ejected, the actual dyeing tends to be uneven or the dyeing tends to be uneven in appearance in the case of the fluffy fabric as compared with the case of the fabric without fluff.

The evenness of dye characteristic acquisition unit 240 acquires the evenness of dye characteristic information PE using the texture values Dtx based on the texture images TIM1 to TIM4 obtained by imaging the fabric for texture acquisition of the same type as the fabric of the print medium. The evenness of dye characteristic information PE is information indicating that the evenness of dye is high or not high. The details of the processing of the evenness of dye characteristic acquisition unit 240 will be described later.

The transmission characteristic acquisition unit 250 acquires the transmission characteristic information TR indicating the transmission characteristic of light with respect to the fabric. The transmission characteristic acquisition unit 250 acquires the transmission characteristic information TR using the texture values Dtx based on the texture images TIM1 to TIM4 obtained by imaging the fabric for texture acquisition of the same type as the fabric of the print medium. The details of the transmission characteristic information processing will be described later.

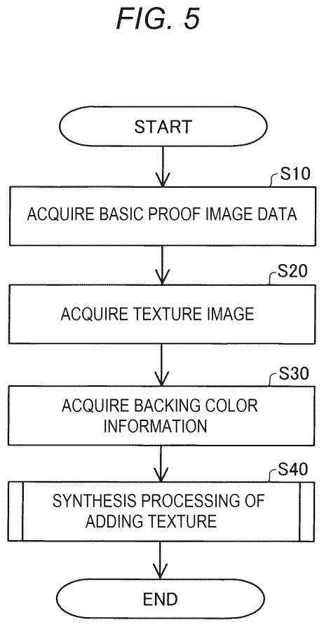

FIG. 5 is a flowchart showing a procedure of creation processing of the proof image data. In step S10, the basic proof image acquisition unit 210 acquires the basic proof image data BPF. In step S20, the texture information acquisition unit 220 reads and acquires the texture images TIM1 to TIM4 obtained by imaging the fabric for texture acquisition of the same type as the fabric of the print medium from the storage unit 202.

In step S30, the backing color information acquisition unit 230 acquires backing color information BI. Here, the backing color information acquisition unit 230 acquires the backing color information BI including a basic backing color BBC, an observation backing color OBC, a first backing color TBC1 of the first backing Back1 for texture acquisition, and a second backing color TBC2 of the second backing Back2 for texture acquisition.

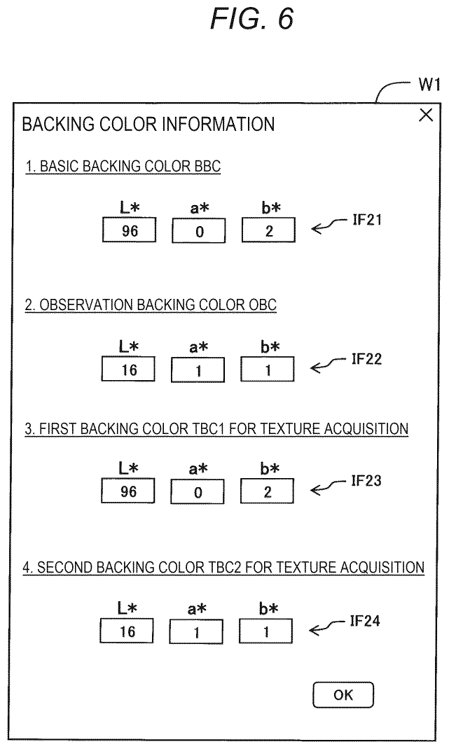

FIG. 6 shows an example of a window W1 used for acquiring the backing color information BI. The window W1 is provided with an input field IF21 for inputting the basic backing color BBC, an input field IF22 for inputting the observation backing color OBC, an input field IF23 for inputting the first backing color TBC1, and an input field IF24 for inputting the second backing color TBC2. In the present embodiment, the basic backing color BBC, the observation backing color OBC, the first backing color TBC1, and the second backing color TBC2 are set by Lab values. In the example of FIG. 6, the basic backing color BBC is white, the observation backing color OBC is black, the first backing color is white, and the second backing color is black. The color of each backing can be changed as appropriate.

The basic backing color BBC, the observation backing color OBC, the first backing color TBC1, and the second backing color TBC2 may be acquired as images. That is, the backing color information acquisition unit 230 may acquire a Lab image of the observation backing color OBC designated by a user.

As illustrated in FIG. 5, in step S40, synthesis processing of adding a texture to the basic proof image data BPF is executed using the texture information TI, and texture-added proof image data is created. In the present embodiment, the details of the synthesis processing differ depending on the type of fabric of the print medium.

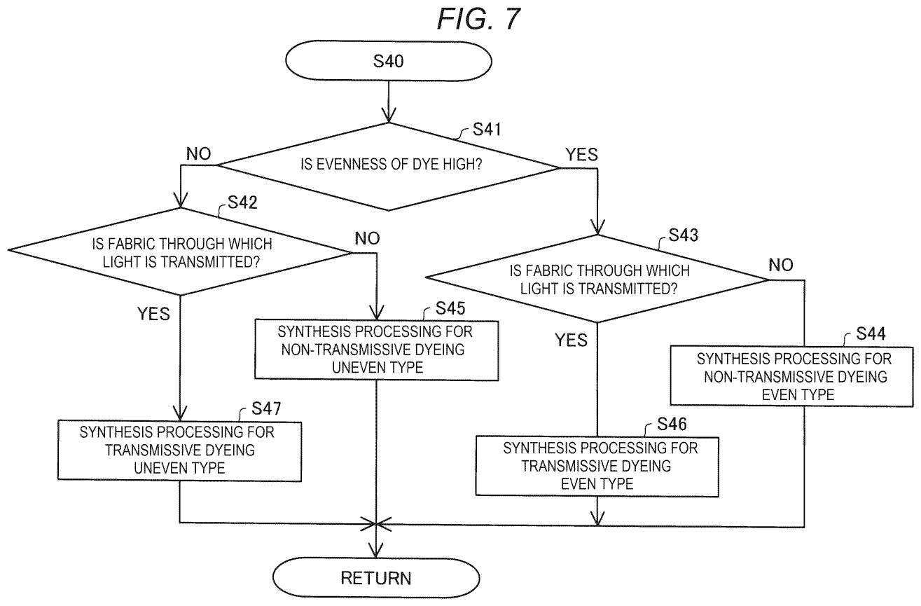

FIG. 7 is a flowchart showing a detailed procedure of step S40. In step S41, the evenness of dye characteristic acquisition unit 240 determines whether the evenness of dye of the fabric for texture acquisition is high.

The evenness of dye characteristic acquisition unit 240 determines whether the evenness of dye is high in the following manner. First, the evenness of dye characteristic acquisition unit 240 calculates a variance of the lightness constituting the first texture value Dtx1 based on the texture image TIM1 obtained by imaging the fabric for texture acquisition of the same type as the fabric of the print medium. The calculated variance is referred to as Sp1. An expression (M1) for calculating the variance is shown below.

$$\begin{matrix}[ Math . 1 ] & \\ {S}^{2} = \frac{1}{n} {\sum }_{i = 1}^{n} {( {x}_{i} - \overline{x} )}^{2} & ( M1 )\end{matrix}$$

The evenness of dye characteristic acquisition unit 240 calculates the variance of the lightness constituting the fourth texture value Dtx4 based on the texture image TIM4 obtained by imaging the fabric for texture acquisition of the same type as the fabric of the print medium by the expression (M1). The calculated variance is referred to as Sp4.

When a condition that the variance Sp4 is larger than the variance Sp1 and the variance Sp4 is M times (M is a positive rational number) the variance Sp1 is satisfied, the evenness of dye characteristic acquisition unit 240 determines that the evenness of dye of the ink in the fabric of the print medium is not high. When the above condition is not satisfied, the evenness of dye characteristic acquisition unit 240 determines that the evenness of dye of the fabric of the print medium is high. As illustrated in FIG. 3, the evenness of dye characteristic acquisition unit 240 outputs information indicating that the evenness of dye is high or not high to the transmission characteristic acquisition unit 250 as the evenness of dye characteristic information PE.

As described above, in the case of the fabric having a large amount of fluff, the actual dyeing tends to be uneven or the dyeing tends to be uneven in appearance as compared with the fabric without fluff.

Therefore, it is assumed that the variance of the lightness of the pixels constituting the captured image increases. In contrast, in the case of a fabric having a small amount of fluff, it is assumed that the variance of the lightness of the pixels constituting the captured image becomes small because the dyeing is even. Therefore, the evenness of dye characteristic acquisition unit 240 determines whether the evenness of dye is high using the variance of the first texture value Dtx1 based on the texture image TIM1 and the variance of the fourth texture value Dtx4 based on the texture image TIM4. The texture image TIM1 is an image obtained by imaging the non-print area with the white first backing Back1 as a background. The texture image TIM4 is an image obtained by imaging a print area in which black is printed in the device-dependent color space with the black second backing Back2 as a background. By using the first texture value Dtx1 based on the texture image TIM1 and the fourth texture value Dtx4 based on the texture image TIM4 in which the color of the backing and the color of the fabric are set close to each other, the color of the fabric and the color of the backing can be made the same. Therefore, it is possible to prevent the light transmitted through the fabric from affecting the lightness of the texture image. Therefore, it is possible to prevent the required value of the variance of the lightness from being affected by the light transmitted through the fabric.

As shown in FIG. 7, when it is determined that the evenness of dye is not high (step S41; NO), the processing of step S42 is executed. When it is determined that the evenness of dye is high (step S41; YES), processing of step S43 is executed.

In step S42, the transmission characteristic acquisition unit 250 determines whether the fabric of the print medium is a fabric through which light is transmitted. Examples of the fabric through which light is transmitted include a fabric having a gap in a certain size between threads and a fabric woven with a translucent thread. In the present embodiment, in order to specify the texture of the fabric, it is determined whether the fabric of the print medium transmits light, and transmission characteristic information described later is acquired.

The transmission characteristic acquisition unit 250 determines whether the fabric of the print medium is a fabric through which light is transmitted in the following manner. First, the transmission characteristic acquisition unit 250 calculates an average of the lightness constituting the third texture value Dtx3 based on the texture image TIM3 obtained by imaging the fabric for texture acquisition of the same type as the fabric of the print medium. The calculated average is referred to as Av3. The transmission characteristic acquisition unit 250 calculates an average of the lightness constituting the fourth texture value Dtx4 based on the texture image TIM4 obtained by imaging the fabric for texture acquisition of the same type as the fabric of the print medium. The calculated average is referred to as Av4.

The transmission characteristic acquisition unit 250 calculates average transmittance the following expression (M2)

$$average transmittance = 1 - ( ( 100 - Av 3 ) / ( 100 - Av 4 ) . \qquad ( M2 )$$

When the average transmittance calculated by the expression (M2) is equal to or greater than a predetermined threshold Th2, the transmission characteristic acquisition unit 250 determines that the fabric of the print medium is a fabric through which light is transmitted. In contrast, when the calculated average transmittance is less than the predetermined threshold Th2, the transmission characteristic acquisition unit 250 determines that the fabric of the print medium is not a fabric through which light is transmitted, that is, a fabric through which light is not transmitted.

When it is determined that the fabric is not a fabric through which light is transmitted (step S42; NO), that is, when it is determined that the fabric is a fabric through which light is not transmitted, processing of step S45 is executed. When it is determined that the fabric is a fabric through which light is transmitted (step S42; YES), processing of step S47 is executed.

In step S43, the transmission characteristic acquisition unit 250 determines whether the fabric of the print medium is a fabric through which light is transmitted.

First, the transmission characteristic acquisition unit 250 calculates an average of the lightness constituting the first texture value Dtx1 based on the texture image TIM1 obtained by imaging the fabric for texture acquisition of the same type as the fabric of the print medium. The calculated average is referred to as Av1. The transmission characteristic acquisition unit 250 calculates an average of the lightness constituting the second texture value Dtx2 based on the texture image TIM2 obtained by imaging the fabric for texture acquisition of the same type as the fabric of the print medium. The calculated average is referred to as Av2.

The transmission characteristic acquisition unit 250 calculates the average transmittance by the following expression (M3)

$$average transmittance = 1 - Av 2 / Av 1. \qquad ( M3 )$$

When the average transmittance calculated by the expression (M3) is equal to or greater than a predetermined threshold Th3, the transmission characteristic acquisition unit 250 determines that the fabric of the print medium is a fabric through which light is transmitted. In contrast, when the calculated average transmittance is less than the predetermined threshold Th3, the transmission characteristic acquisition unit 250 determines that the fabric of the print medium is not a fabric through which light is transmitted, that is, a fabric through which light is not transmitted.

As described above, when the evenness of dye is not high, the third lightness map and the fourth lightness map based on the image obtained by imaging the print area are used in step S42. In contrast, in step S43, when the evenness of dye is high, the first lightness map and the second lightness map based on the image obtained by imaging the non-print area are used. In this way, it is possible to easily determine whether the fabric is a light-transmissive fabric using the four types of texture images.

In step S43, when it is determined that the fabric is not a fabric through which light is transmitted (step S43; NO), that is, when it is determined that the fabric is a fabric through which light is not transmitted, processing of step S44 is executed. When it is determined that the fabric is a fabric through which light is transmitted (step S43; YES), processing of step S46 is executed.

### Fabric of (T1) Non-Transmissive Dyeing Even Type

In step S44, synthesis processing of adding a texture to a fabric through which light is not transmitted and which has high evenness of dye, that is, the fabric of (T1) non-transmissive dyeing even type is executed.

The synthesis unit 260 can execute the same processing as the processing disclosed in, for example, JP-A-06-86045 in order to add a texture.

Specifically, a value obtained by multiplying the difference between the average value of the texture values Dtx and each texture value Dtx by a gain may be added to the pixel value of the basic proof image data BPF. Here, when the fabric of the print medium is the non-transmissive dyeing even type, the first texture value Dtx1 based on the texture image TIM1 obtained by imaging the fabric of (T1) the non-transmissive dyeing even type is used as the fabric for texture acquisition. The texture may be added according to another known method. When the basic proof image data BPF is expressed by the Lab color system, the texture addition processing may be executed only for the lightness. When the basic proof image data BPF is expressed by the RGB color system, the texture addition processing may be executed for each color component of RGB. The synthesis unit 260 is also referred to as a “texture-added proof image data creation unit”.

### Fabric of (T3) Non-Transmissive Dyeing Uneven Type

In step S45, synthesis processing of adding a texture to a fabric through which light is not transmitted and which does not have high evenness of dye, that is, (T3) the fabric of non-transmissive dyeing uneven type is executed.

The synthesis unit 260 can execute the same processing as the processing disclosed in, for example, JP-A-06-86045 in order to add a texture. Specifically, a value obtained by multiplying the difference between the average value of the texture values Dtx and each texture value Dtx by a gain may be added to the pixel value of the basic proof image data BPF. Here, when the fabric of the print medium is the non-transmissive dyeing uneven type, the fourth texture value Dtx4 based on the texture image TIM4 obtained by imaging (T3) the fabric of non-transmissive dyeing uneven type as the fabric for texture acquisition is used.

### Fabric of (T2) Transmissive Dyeing Even Type

In step S46, synthesis processing of adding a texture is executed in a case of a fabric through which light is transmitted and which has high evenness of dye, that is, a fabric of (T2) the transmissive dyeing even type.

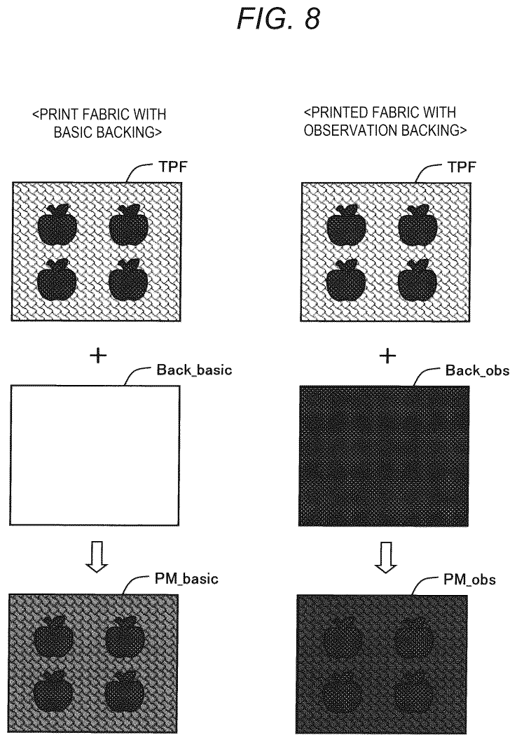

FIG. 8 shows examples of a light-transmissive fabric to which different backings are applied. On the left side in FIG. 8, a basic printed matter PM_basic in a state where a basic backing back basic is applied to a print fabric TPF without backing illustrated. The color of the basic backing back basic is, for example, white. On the right side in FIG. 8, an observation printed matter PM_obs in a state where an observation backing Back_obs is applied to the print fabric TPF without backing is illustrated. The color of the observation backing Back_obs is, for example, black. The basic proof image data BPF is data representing the color of the basic printed matter PM_basic.

The synthesis unit 260 can use the method described in Japanese Patent Application No. 2024-207035 (hereinafter, referred to as Prior Application 1) filed by the applicant of the present disclosure when executing the synthesis processing of adding a texture.

### Processing for Determining Basic Color Mixture Ratio

The synthesis unit 260 determines a basic color mixing ratio according to the texture information TI. As described above, when the print medium is of (T2) the transmissive dyeing even type or (T4) the transmissive dyeing uneven type, the texture information TI includes the transmission characteristic information TR in addition to the texture value Dtx.

The basic color mixing ratio is a color mixing ratio of the basic backing color BBC when the color of the basic printed matter PM_basic illustrated in FIG. 8 is regarded as a color mixture of the color of the print fabric TPF and the basic backing color BBC. In other words, the basic color mixture ratio is a color mixture ratio of the basic backing color BBC when the color represented by the basic proof image data BPF is a color mixture of the color represented by foreground color proof image data FPF and the basic backing color BBC. The foreground color proof image data FPF is data representing the color of the print fabric TPF without using a backing.

When the basic color mixing ratio is Rmix_basic, the color mixture with respect to the basic proof image data BPF is expressed by the following expression

$$Lab\_basic = Lab\_fore \times ( 1 - Rmix\_basic ) + Lab\_b . back \times Rmix\_basic \qquad ( q1 )$$

where Lab_basic is a Lab value of the basic proof image data BPF, Lab_fore is a Lab value of the foreground color proof image data FPF, and Lab_b.back is a Lab value of the basic backing color BBC.

The basic color mixing ratio Rmix_basic is a value more than 0 and less than 1.0.

The transmission characteristic information TR used to determine the basic color mixture ratio Rmix_basic includes the following four setting values. Prior Application 1 discloses an example in which the user inputs the following four setting values, but in the present embodiment, the transmission characteristic acquisition unit 250 calculates the following four setting values in step S46. A method of calculating the four setting values will be described later.

### (1) On-thread Texture Threshold Th_thread

An on-thread texture threshold Th_thread is the minimum value of the texture value Dtx for determining that each pixel corresponds to a portion on the weaving thread of the fabric.

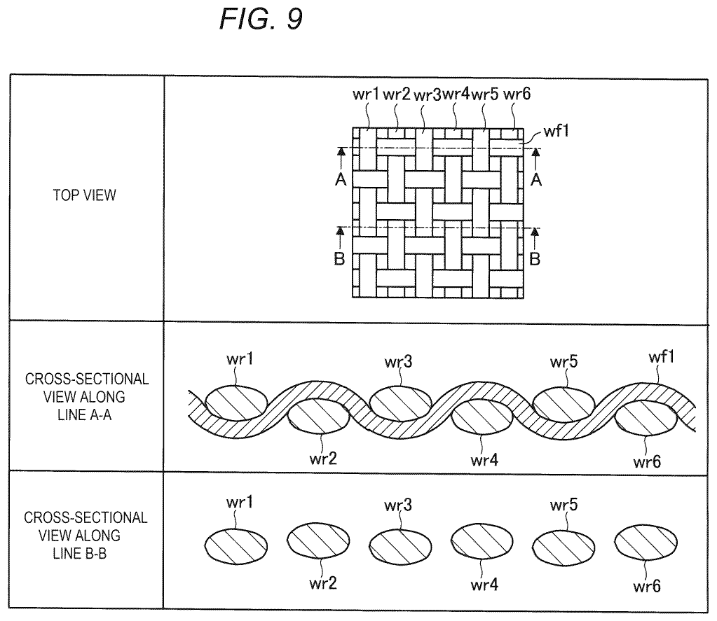

FIG. 9 is a top view and cross-sectional views of an example of the fabric. The term “a portion on the weaving thread” refers to a portion of the weaving threads constituting the fabric, which is not located under the other weaving thread when the woven or knitted fabric is viewed in cross section. In the cross-sectional view taken along line A-A in FIG. 9, the warp threads wr1, wr3, and wr5 are not located under other weaving threads. In the cross-sectional view along line A-A, the warp threads wr2, wr4, and wr6 are located under a weft thread wfl. In the cross-sectional view taken along line B-B of FIG. 9, the warp threads wr1 to wr6 are not located under the other weaving threads. As described above, the portion of the thread that is not located under the other weaving thread includes the portion of the thread that is located on the other weaving thread and the portion of the thread that is not located on any weaving thread. In other words, “a portion on the weaving thread” refers to a portion of the thread appearing on the side at which the fabric is viewed. A pixel having the texture value Dtx equal to or greater than the on-thread texture threshold Th_thread is determined to correspond to a portion on the weaving thread. The on-thread texture threshold Th_thread is set to, for example, a value more than 0 and 100 or less. In the example shown in FIG. 4, the pixel determined to correspond to a portion on the weaving thread when Th_thread=100 is shown as a white area without hatching.

When the print medium is of (T2) the transmissive dyeing even type, the texture value for determination is the second texture value Dtx2 based on the texture image TIM2 obtained by imaging the fabric of (T2) the transmissive dyeing even type as the fabric for texture acquisition. Or, in step S47 to be described later, when the print medium is of (T4) the transmissive dyeing uneven type, the texture value for determination is the third texture value Dtx3 based on the texture image TIM3 obtained by imaging the fabric of (T4) the transmissive dyeing uneven type as the fabric for texture acquisition. The same applies to the following setting values (2) to (4).

### (2) Gap Texture Threshold Th_hole

A gap texture threshold Th_hole is the maximum value of the texture value Dtx for determining that each pixel corresponds to a gap between weaving threads of the fabric. That is, a pixel having the texture value Dtx equal to or less than the gap texture threshold Th_hole is determined to correspond to a gap between weaving threads. There is no thread in the gap between weaving threads. When a backing is applied, the backing can be seen through the gap between weaving threads. The gap texture threshold Th_hole is set to, for example, a value of 0 or more and less than 100. Furthermore, the gap texture threshold Th_hole is set to a value (darker value) smaller than the on-thread texture threshold Th_thread. In the example of FIG. 4, a pixel determined to correspond to a gap between weaving threads when Th_hole=50 is shown as a dark gray area. Furthermore, a pixel having an intermediate lightness between the thread and the gap is shown as a light gray area.

### (3) On-Thread Background Reference Rate Rb_Thread

An on-thread background reference rate Rb_thread is a rate for reference to the backing color in the pixel corresponding to portion on the weaving thread. Reference to the backing color means that the appearance of the fabric is affected by the backing color. As the backing color, the basic backing color or the observation backing color is referred to. The on-thread background reference rate Rb_thread is set to, for example, a value from 0 to 1.0.

### (4) Gap Background Reference Rate Rb_Hole

A gap background reference rate Rb_hole is a rate for reference to the backing color in the pixel corresponding to the gap. The gap background reference rate Rb_hole is set to, for example, a value from 0 to 1.0. The gap background reference rate Rb_hole is set to a value larger than the on-thread background reference rate Rb_thread.

The fabric is produced by weaving threads. Therefore, the color of the backing applied to the back of the fabric may be seen through the gap between weaving threads, and the appearance of the fabric is affected. Even in a case of a tightly-woven fabric, the appearance of the fabric is affected by the thickness of the fabric, the color of the backing applied to the back of the fabric, and the like. The appearance of the portion of the weaving thread is also affected by the color and thickness of the thread, the color of the backing, and the like. The transmission characteristic information is information on the texture of the fabric that affects the appearance of the fabric. By considering the above (1) to (4) as the transmission characteristic information TR, the reproducibility of the texture of the fabric can be improved.

The synthesis unit 260 determines a pixel background reference rate Rb_px, which is a background reference rate of each pixel, according to the texture value Dtx using a background reference rate determination curve determined by the transmission characteristic information. As described above, when the fabric of the print medium is a fabric of the transmissive dyeing even type, the second texture value Dtx2 based on the texture image TIM2 obtained by imaging the fabric of (T2) the transmissive dyeing even type as the fabric for texture acquisition is used.

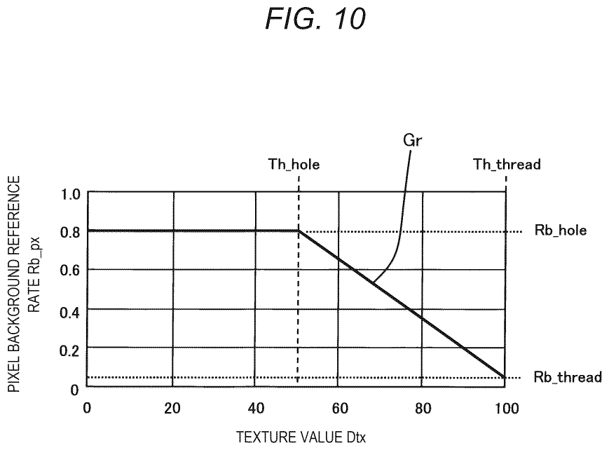

FIG. 10 is a graph showing an example of a background reference rate determination curve Gr. The background reference rate determination curve Gr preferably has a characteristic that the pixel background reference rate Rb_px is lower as the lightness represented by the texture value Dtx is higher. The pixel background reference rate Rb_px is determined as follows according to the texture value Dtx of each pixel.

(a1) Pixel having texture value Dtx equal to or less than gap texture threshold Th_hole:
the pixel background reference rate Rb_px is determined as a value equal to the gap background reference rate Rb_hole.

(a2) Pixel having texture value Dtx that satisfies Th_hole<Dtx<Th_thread:
the pixel background reference rate Rb_px is determined by linear interpolation between the on-thread background reference rate Rb_thread and the gap background reference rate Rb_hole according to the texture value Dtx.

(a3) Pixel having texture value Dtx equal to or more than on-thread texture threshold Th_thread:
the pixel background reference rate Rb_px is determined as a value equal to the on-thread background reference rate Rb_thread.

As described above, in the present embodiment, it is possible to easily calculate the on-thread texture threshold, the gap texture threshold, the on-thread background reference rate, and the gap background reference rate as the transmission characteristic information indicating the transmission characteristics of the fabric for texture acquisition using the four lightness maps.

The synthesis unit 260 calculates an average background reference rate Rb_ave by averaging the pixel background reference rates Rb_px in the image area of the basic proof image data BPF.

The synthesis unit 260 determines the basic color mixing ratio Rmix_basic using the average background reference rate Rb_ave or the pixel background reference rate Rb_px. For example, the basic color mixing ratio Rmix_basic is determined by one of the following expressions

$$Rmix\_basic = Rb\_ave \qquad ( q2 - 1 )$$

$$Rmix\_basic = Rb\_px . \qquad ( q2 - 2 )$$

As the basic color mixing ratio Rmix_basic, a positive value proportional to the average background reference rate Rb_ave or the pixel background reference rate Rb_px can be used instead of the value itself of the average background reference rate Rb_ave or the pixel background reference rate Rb_px.

When the basic color mixing ratio Rmix_basic is determined using the average background reference rate Rb_ave, a constant basic color mixing ratio Rmix_basic is applied to the entire image area. In contrast, when the basic color mixing ratio Rmix_basic is determined using the pixel background reference rate Rb_px, a different basic color mixing ratio Rmix_basic is applied for each pixel. In the latter case, the processing of calculating the average background reference rate Rb_ave may be omitted. However, the basic color mixing ratio Rmix_basic is preferably determined using the average background reference rate Rb_ave rather than the pixel background reference rate Rb_px. This is because, when the basic color mixing ratio Rmix_basic is determined using the pixel background reference rate Rb_px, the correction amount in color correction processing becomes excessively larger in the gap portion between fibers, and the color of the foreground color proof image data FPF may not be correctly obtained. In an actual light-transmissive print fabric, spatial color mixture of the gap portion and the thread portion is produced, and it is considered that an averaged color is seen when observed from a distance. Therefore, in the color correction processing, it is preferable to generate the foreground color proof image data FPF so as to more accurately represent the actually observed color of the light-transmissive print fabric by removing the basic backing color using the average background reference rate Rb_ave.

### Processing for Creating Foreground Color Proof Image Data

The synthesis unit 260 creates the foreground color proof image data FPF by executing color correction processing of removing the basic backing color BBC from the color represented by the basic proof image data BPF according to the basic color mixing ratio Rmix_basic. As described above, the foreground color proof image data FPF is data representing the color of the print fabric TPF observed without using a backing.

The calculation of the color correction processing is executed, for example, according to the following expression

$$Lab\_fore = ( Lab\_basic - Lab\_b . back \times Rmix\_basic ) / ( 1 - Rmix\_basic ) \qquad ( q3 )$$

where Lab_fore is the Lab value of the foreground color proof image data FPF, Lab_basic is the Lab value of the basic proof image data BPF, Lab_b.back is the Lab value of the basic backing color BBC, and Rmix_basic is the basic color mixing ratio.

The calculation by the expression (q3) is executed for each of the L value, the a value, and the b value of the basic proof image data BPF. The expression (q3) corresponds to a modification of the expression (q1) described above.

### Processing for Determining Observation Color Mixing Ratio

The synthesis unit 260 determines an observation color mixing ratio according to the texture information TI. The observation color mixing ratio is a color mixing ratio when the color of the observation printed matter PM_obs illustrated in FIG. 8 is regarded as a color mixture of the color of the print fabric TPF and the observation backing color OBC. In other words, the observation color mixing ratio is a color mixing ratio when the color represented by the observation proof image data OPF is a color mixture of the color represented by the foreground color proof image data FPF and the observation backing color OBC.

In the present embodiment, a positive value proportional to the average background reference rate Rb_ave or the pixel background reference rate Rb_px is used as the observation color mixing ratio Rmix_obs. For example, the value itself of the average background reference rate Rb_ave or the pixel background reference rate Rb_px may be used as the observation color mixing ratio Rmix_obs.

The observation color mixing ratio Rmix_obs may be the same as or different from the basic color mixing ratio Rmix_basic described above. However, it is preferable to use a value proportional to the average background reference rate Rb_ave as the basic color mixing ratio Rmix_basic and a value proportional to the pixel background reference rate Rb_px as the observation color mixing ratio Rmix_obs. When a value proportional to the pixel background reference rate Rb_px is used as the observation color mixing ratio Rmix_obs, the differences between the background and the foreground in the thread portion and the gap portion become clear, so that the texture of the light-transmissive fabric can be reproduced more appropriately.

### Processing for Creating Observation Proof Image Data

The synthesis unit 260 creates the observation proof image data OPF by executing synthesis processing of synthesizing the observation backing color OBC with the color represented by the foreground color proof image data FPF according to the observation color mixing ratio Rmix_obs. The observation proof image data OPF is data representing the color of the observation printed matter PM_obs illustrated in FIG. 8.

The synthesis processing is executed according to, for example, the following expression

$$Lab\_obs = Lab\_fore \times ( 1 - Rmix\_obs ) + Lab\_o . back \times Rmix\_obs \qquad ( q5 )$$

where Lab_obs is the Lab value of the observation proof image data OPF, Lab_fore is the Lab value of the foreground color proof image data FPF, Lab_o.back is the Lab value of the observation backing color OBC, and Rmix_obs is the observation color mixing ratio.

By using the observation proof image data OPF generated in this manner, it is possible to reproduce, as a proof, the observation printed matter PM_obs of the print fabric TPF observed when an optional observation backing Back_obs is used.

### Fabric of (T4) Transmissive Dyeing Uneven Type

As illustrated in FIG. 7, in step S47, synthesis processing of adding a texture is executed in a case of a fabric through which light is transmitted and which does not have high evenness of dye, that is, a fabric of (T4) the transmissive dyeing uneven type. The synthesis unit 260 can execute the same processing as that in the case of the fabric of (T2) the transmissive dyeing even type in order to add a texture. However, when the fabric of the print medium is a fabric of the transmissive dyeing uneven type, the third texture value Dtx3 based on the texture image TIM3 obtained by imaging a fabric of (T4) the transmissive dyeing uneven type as the fabric for texture acquisition is used.

Subsequently, methods of calculating (1) the on-thread texture threshold Th_thread, (2) the gap texture threshold Th_hole, (3) the on-thread background reference rate Rb_thread, and (4) the gap background reference rate Rb_hole used in step S46 and step S47 of FIG. 7 will be described. These values are calculated by the transmission characteristic acquisition unit 250 in steps S46 and S47.

### (1) Calculation of On-thread Texture Threshold Th_thread

The on-thread texture threshold Th_thread is calculated in the following manner. The following processing is the same when the fabric of the print medium is the fabric of (T2) the transmissive dyeing even type and the fabric of (T4) the transmissive dyeing uneven type.

First, the transmission characteristic acquisition unit 250 obtains a maximum lightness LH1 having the maximum value and a minimum lightness LL1 having the minimum value among the lightness constituting the first texture value Dtx1 based on the texture image TIM1 obtained by imaging the fabric of the same type as the print medium. Furthermore, the transmission characteristic acquisition unit 250 obtains a maximum lightness LH2 having the maximum value and a minimum lightness LL2 having the minimum value among the lightness constituting the second texture value Dtx2 based on the texture image TIM2 obtained by imaging the fabric of the same type as the print medium.

When the maximum lightness LH2 exceeds the maximum lightness LH1, the transmission characteristic acquisition unit 250 calculates a normalized value of the on-thread texture threshold Th_thread by the following expression (M4)

$$normalized value of on - thread texture threshold = ( 1 - ( LH 2 - LL 1 ) / ( LH 2 - LL 2 ) ) \times 100. \qquad ( M4 )$$

When the maximum lightness LH2 is equal to or less than the maximum lightness LH1, the transmission characteristic acquisition unit 250 calculates a normalized value of the on-thread texture threshold Th_thread by the following expression (M5)

$$normalized value of on - thread texture threshold = 100. \qquad ( M5 )$$

As illustrated in FIG. 4, each lightness in the map constituting the texture value Dtx is a normalized value and takes a value in a range from 0 (black) to 100 (white). Therefore, the normalized values of the on-thread texture thresholds calculated by the expressions (M4) and (M5) are required to be converted by the following expression (M6)

$$on - thread texture threshold = normalized value of on - thread texture threshold \times ( maximum lightness LH 2 - minimum lightness LL 2 ) \text{} / 100 + minimum lightness LL 2. \qquad ( M6 )$$

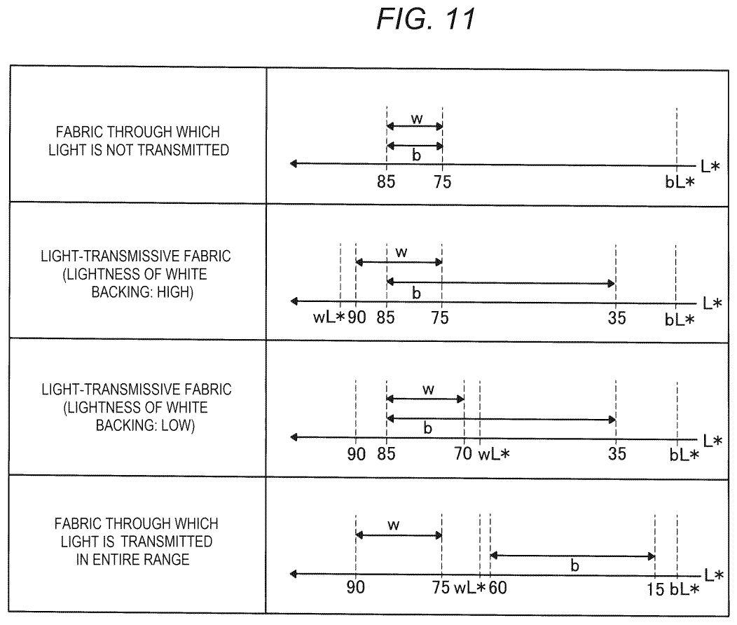

FIG. 11 shows an example of measurement results of distributions of lightness constituting texture values Dtx in maps. The first row of FIG. 11 illustrates a lightness distribution based on a captured image of a fabric through which light is not transmitted. This fabric is of (T1) the non-transmissive dyeing even type or (T3) non-transmissive dyeing uneven type. A lightness distribution based on a captured image obtained by imaging the non-print area of the fabric lined with a white backing is shown by an arrow w, and a lightness distribution based on a captured image obtained by imaging the non-print area of the fabric lined with a black backing is shown by an arrow b. The horizontal axis indicates the lightness, and the lightness increases toward the left. bL* indicates the lightness of the black backing. The lightness of the black backing is an example, and does not match the value designated by the user in FIG. 6. The same applies to the drawings described below. In the case of a fabric through which light is not transmitted, the range of the lightness distribution is the same regardless of the color of the backing.

The second and third rows of FIG. 11 illustrate lightness distributions in captured images of a fabric including a range in which light is transmitted and a range in which light is not transmitted. This fabric is of (T4) the transmissive dyeing uneven type, and corresponds to, for example, a woven fabric using a thread for knitting whose main raw material is natural hair. In each of the second row and the third row, a lightness distribution based on a captured image obtained by imaging the non-print area of the fabric lined with a white backing is shown by an arrow w, and a lightness distribution based on a captured image obtained by imaging the non-print area of the fabric lined with a black backing is shown by an arrow b. wL* indicates the lightness of the white backing.

The lightness of the white backing are different between the example shown in the second row and the example shown in the third row. The second row shows the lightness distribution when the lightness wL* of the white backing exceeds the maximum lightness on the thread. The lightness of the white backing is an example, and does not match the value designated by the user in FIG. 6. The third row shows the lightness distribution of the fabric when the maximum lightness on the thread is equal to or higher than the lightness wL* of the white backing.

As shown in the second and third rows, the lightness based on the captured image obtained by imaging the fabric lined with the white backing is distributed in a range close to that of the lightness wL* of the white backing. Although not illustrated, a similar lightness distribution is observed in (T2) the transmissive dyeing even type.

The fourth row shows a lightness distribution in a captured image of a fabric through which light is transmitted in the entire range. This fabric is of (T2) the transmissive dyeing even type, and examples thereof include chiffon, organdy, and georgette. A lightness distribution based on a captured image obtained by imaging the non-print area of the fabric lined with a white backing is shown by an arrow w, and a lightness distribution based on a captured image obtained by imaging the non-print area of the fabric lined with a black backing is shown by an arrow b.

As shown in the fourth row, when light is transmitted through the entire range, the lightness distribution based on the captured image obtained by imaging the fabric lined with the white backing does not overlap the range of the lightness distribution based on the captured image obtained by imaging the fabric lined with the black backing. Although not illustrated, a similar lightness distribution is also observed in (T4) the transmissive dyeing uneven type. In contrast, as shown in the first row, when light is not transmitted, the range of the lightness distribution is the same regardless of the color of the backing.

As described above, in the present disclosure, a portion where the lightness distribution when the white backing is used and the lightness distribution when the black backing is used overlap is regarded as a portion on the weaving thread of the fabric, that is, a portion where the weaving thread is seen. The above expressions (M4) to (M6) are formulated based on these studies.

### (2) Calculation of Gap Texture Threshold Th_hole

The gap texture threshold Th_hole is calculated in the following manner. The following processing is the same when the fabric of the print medium is the fabric of (T2) the transmissive dyeing even type and the fabric of (T4) the transmissive dyeing uneven type.

$$gap texture threshold = lightness of black backing + correction value α \qquad ( M7 )$$

When a black backing is used, the color of the black backing should be reproduced in the gaps between weaving threads of the fabric. However, in consideration of variations in lightness in the captured image due to light reflected by the black backing at the time of imaging, a value obtained by adding the correction value α to the lightness of the black backing is set as the gap texture threshold in the expression (M7). The correction value α is, for example, 5. The lightness of the black backing is also referred to as “black lightness”.

### (3) Calculation of On-Thread Background Reference Rate Rb_thread

The on-thread background reference rate Rb_thread is calculated in the following manner. The following processing is the same when the fabric of the print medium is the fabric of (T2) the transmissive dyeing even type and the fabric of (T4) the transmissive dyeing uneven type.

The transmission characteristic acquisition unit 250 calculates the on-thread background reference rate Rb_thread by the following expression (M8) using the maximum lightness LH1 and the maximum lightness LH2

$$on - thread background reference rate = ( LH 1 - LH 2 ) / ( LH 1 - lightness of black backing ) . \qquad ( M8 )$$

### (4) Calculation of Gap Background Reference Rate Rb_hole

The gap background reference rate Rb_hole is calculated in the following manner. The following processing is the same when the fabric of the print medium is the fabric of (T2) the transmissive dyeing even type and the fabric of (T4) the transmissive dyeing uneven type.

The transmission characteristic acquisition unit 250 calculates the gap background reference rate Rb_hole by the following expression (M9) using the maximum lightness LH1 and the minimum lightness LL2

$$gap background reference rate = ( LH 1 - LL 2 ) / ( LH 1 - lightness of black backing ) . \qquad ( M9 )$$

As described above, in the present embodiment, it is possible to improve the reproducibility of the texture of the medium in the texture-added proof image data to which the texture is added in the proof image representing the medium through which the background is seen through. Furthermore, it is possible to easily obtain the on-thread texture threshold, the gap texture threshold, the on-thread background reference rate, and the gap background reference rate as the transmission characteristic information by using the lightness maps based on the four types of texture images that can be acquired by the combinations of printing and non-printing and the two backing colors.

### B. Other Embodiments

(B1) In the embodiment described above, the example has been described in which the method described in Prior Application 1 filed by the applicant of the present disclosure is used when the synthesis unit 260 executes the synthesis processing of adding a texture. The synthesis unit 260 may use a method described in Japanese Patent Application No. 2024-207036 (hereinafter, referred to as Prior Application 2) filed by the applicant of the present disclosure. Hereinafter, regarding the method described in Prior Application 2, a configuration different from that of Prior Application 1 will be described.

In Prior Application 2, in order to change the appearance of the observation backing color OBC according to the lightness of the basic proof image data BPF, the observation color mixing ratio Rmix_obs is set to change depending on the lightness of the basic proof image data BPF.

In Prior Application 2, (5) a background reference rate correction coefficient K_set of a black area is used in addition to (1) the on-thread texture threshold Th_thread, (2) the gap texture threshold Th_hole, (3) the on-thread background reference rate Rb_thread, and (4) the gap background reference rate Rb_hole described above.

### (5) Background Reference Rate Correction Coefficient K_set of Black Area

background reference rate correction The coefficient K_set of the black area is a setting value of an adjustment coefficient for adjusting the background reference rate in the pixel of the black area. The background reference rate correction coefficient K_set is set to, for example, a value more than 0 and 1.0 or less. The background reference rate correction coefficient K_set of the black area is also referred to as a “black area background reference rate”.

The synthesis unit 260 determines an adjustment coefficient K_corr of the background reference rate according to the lightness of the basic proof image data BPF. The adjustment coefficient K_corr is determined so as to change depending on the lightness of the basic proof image data BPF using an adjustment coefficient determination curve determined by the transmission characteristic information.

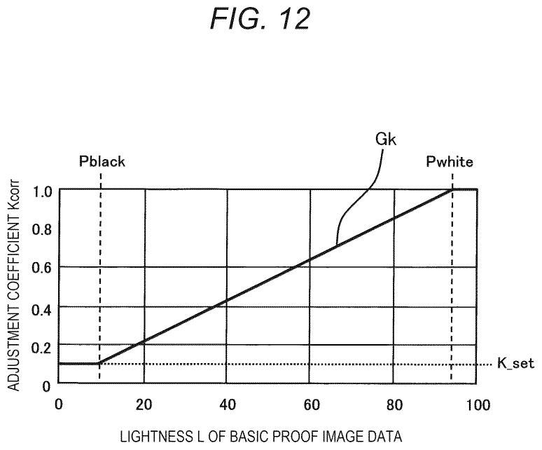

FIG. 12 is a graph showing an example of an adjustment coefficient determination curve Gk. The adjustment coefficient K_corr is determined as follows according to the background reference rate correction coefficient K_set of the black area contained in the transmission characteristic information TR and a white point Pwhite and a black point Pblack contained in the media profile of the fabric.

(b1) Pixel having lightness L of basic proof image data BPF equal to or less than black point Pblack:
the adjustment coefficient K_corr is determined as a value equal to the background reference rate correction coefficient K_set.

(b2) Pixel having lightness L of basic proof image data BPF that satisfies Pblack<L<Pwhite:
the adjustment coefficient K_corr is determined by linear interpolation between the background reference rate correction coefficient K_set and 1.0 according to the lightness L.

(b3) Pixel having lightness L of basic proof image data BPF equal to or more than white point Pwhite:
the adjustment coefficient K_corr is determined as 1.0.

The synthesis unit 260 determines the basic color mixing ratio Rmix_basic using a value obtained by multiplying the average background reference rate Rb_ave or the pixel background reference rate Rb_px by the adjustment coefficient K_corr. For example, the basic color mixing ratio Rmix_basic is calculated by one of the following expressions

$$Rmix\_basic = K\_corr \times Rb\_ave \qquad ( q3 - 1 )$$

$$Rmix\_basic = K\_corr \times Rb\_px . \qquad ( q3 - 2 )$$

Furthermore, a value obtained by multiplying the average background reference rate Rb_ave or the pixel background reference rate Rb_px by the adjustment coefficient K_corr is used as the observation color mixing ratio Rmix_obs. That is, the observation color mixing ratio Rmix_obs is calculated by one of the following expressions

$$Rmix\_obs = K\_corr \times Rb\_ave \qquad ( q4 - 1 )$$

$$Rmix\_obs = K\_corr \times Rb\_px . \qquad ( q4 - 2 )$$

Similarly to the basic color mixing ratio Rmix_basic, the observation color mixing ratio Rmix_obs is also set to change according to the lightness L of the basic proof image data BPF.

The observation color mixing ratio Rmix_obs may be the same as or different from the basic color mixing ratio Rmix_basic described above. However, it is preferable to use a value obtained by multiplying the average background reference rate Rb_ave by the adjustment coefficient K_corr as the basic color mixing ratio Rmix_basic, and a value obtained by multiplying the pixel background reference rate Rb_px by the adjustment coefficient K_corr as the observation color mixing ratio Rmix_obs. When a value obtained by multiplying the pixel background reference rate Rb_px by the adjustment coefficient K_corr is used as the observation color mixing ratio Rmix_obs, the differences between the background and the foreground in the thread portion and the gap portion become clear, so that the texture of the fabric can be reproduced more appropriately.

The background reference rate correction coefficient K_set of the black area indicates the background reference rate of the black area. Therefore, first, the transmission characteristic acquisition unit 250 obtains an average Lav3 of the lightness constituting the third texture value Dtx3 based on the texture image TIM3 obtained by imaging the fabric of the same type as the print medium. Furthermore, the transmission characteristic acquisition unit 250 obtains an average Lav4 of the lightness constituting the fourth texture value Dtx4 based on the texture image TIM4 obtained by imaging the fabric of the same type as the print medium. The transmission characteristic acquisition unit 250 calculates the background reference rate correction coefficient K_set of the black area using the following expression (M10)

$$background reference rate correction coefficient of black area = 1 - ( 100 - Lav 3 ) / ( 100 - Lav 4 ) . \qquad ( M10 )$$

In a case of a fabric through which light is not transmitted, it is assumed that the range of the lightness distribution based on a captured image obtained by imaging the print area lined with a white backing substantially matches the range of the lightness distribution based on a captured image obtained by imaging the print area lined with a black backing. When the average Lav3 and the average Lav4 are the same, the background reference rate correction coefficient of the black area is 0.

In a case of a fabric through which light is transmitted in the entire range, since the colors of the backings are greatly different between white and black, it is assumed that the range of the lightness distribution based on the captured image obtained by imaging the print area lined with the white backing does not overlap the range of the lightness distribution based on the captured image obtained by imaging the print area lined with the black backing. Accordingly, as the difference between the average Lav3 and the average Lav4 is larger, the background reference rate correction coefficient of the black area takes a larger value.

(B2) In the embodiment described above, the example in which the color of the fabric for texture acquisition is white has been described. However, the color of the fabric for texture acquisition may be other than white. For example, each measurement value obtained by measuring the L value, the a value, and the b value of the fabric for texture acquisition under a standard light source may be stored in the storage unit 202 in advance.

### C. Other Configurations

The present disclosure is not limited to the embodiments described above, and can be implemented in various forms without departing from the scope of the present disclosure. For example, the present disclosure may also be implemented in the following configurations. To solve a part or all of the problems of the present disclosure or to achieve a part or all of the advantages of the present disclosure, the technical features in the above-described embodiments corresponding to the technical features in the following configurations can be replaced or combined as appropriate. Also, any of the technical features can be deleted as appropriate unless described as essential in the present specification.

(1) According to a first aspect of the present disclosure, a method of creating proof image data is provided. The method of creating proof image data includes (a) acquiring basic proof image data for reproducing, by a proof output device, a color distribution of a basic printed matter formed by applying a basic backing to a print fabric obtained by printing an image on a fabric using a printing machine, (b) acquiring four types of texture information based on four types of texture images including (i) an image obtained by imaging a non-print area with no image printed thereon using ink of a fabric for texture acquisition with a first backing as a background, (ii) an image obtained by imaging the non-print area of the fabric for texture acquisition with a second backing having a color different from the first backing as a background, (iii) an image obtained by imaging a print area with an image printed thereon using the ink of the fabric for texture acquisition with the first backing as a background, and (iv) an image obtained by imaging the print area of the fabric for texture acquisition with the second backing as a background, (c) acquiring evenness of dye characteristic information indicating evenness of dye of the ink in the fabric for texture acquisition using the four types of texture information, (d) acquiring transmission characteristic information indicating a degree of light transmission of the fabric for texture acquisition using the four types of texture information, and (e) creating texture-added proof image data by applying texture addition processing using the evenness of dye characteristic information and the transmission characteristic information to the basic proof image data.

According to the configuration, the reproducibility of the texture of the medium can be improved in the texture-added proof image data to which the texture is added in the proof image representing the medium through which the background is seen through.

(2) In the method of creating proof image data according to the aspect, the first backing may be white and the second backing may be black, and the four types of texture information may include a first lightness map generated based on a first texture image obtained by imaging the non-print area with the white first backing as a background, a second lightness map generated based on a second texture image obtained by imaging the non-print area with the black second backing as a background, a third lightness map generated based on a third texture image obtained by imaging the print area with the white first backing as a background, and a fourth lightness map generated based on a fourth texture image obtained by imaging the print area with the black second backing as a background.

(3) In the method of creating proof image data according to the aspect, a Duty value of the ink in the print area contained in the fabric for texture acquisition may be set to be equal to or greater than a predetermined reference value.

According to the configuration, by increasing the duty value of the ink in the print area, it is possible to acquire a texture image in which a difference in lightness is clear in comparison with the non-print area.

(4) In the method of creating proof image data according to the aspect, the print area contained in the fabric for texture acquisition may be an area printed in black in a device-dependent color space.

(5) In the method for creating proof image data according to the aspect, a color of the fabric for texture acquisition may be white, and in (c), when a variance of lightness contained in the fourth lightness map is larger than a variance of lightness contained in the first lightness map and a difference between the variance of the lightness contained in the first lightness map and the variance of the lightness contained in the fourth lightness map is larger than a predetermined value, it may be determined that dyeing of the fabric for texture acquisition with the ink is uneven.

According to the configuration, by using the first texture map based on the first texture image and the fourth texture map based on the fourth texture image in which the color of the backing and the color of the fabric are set close to each other, it is possible to prevent the obtained value of the variance of the lightness from being affected by the light transmitted through the fabric.

(6) The method of creating proof image data according to the aspect may further include (f) determining whether the print fabric is a light-transmissive fabric using the third lightness map and the fourth lightness map when the evenness of dye characteristic information acquired in (c) indicates that the dyeing of the fabric for texture acquisition with the ink is uneven, and (g) determining whether the fabric for texture acquisition is the light-transmissive fabric using the first lightness map and the second lightness map when the evenness of dye characteristic information acquired in (c) indicates that the dyeing of the fabric for texture acquisition with the ink is even.

According to the configuration, in order t determine whether the fabric is the light-transmissive fabric, when the evenness of dye is high, the first lightness map and the second lightness map based on the images obtained by imaging the non-print area are used, and when the evenness of dye is not high, the third lightness map and the fourth lightness map based on the images obtained by imaging the print area are used. It is possible to easily determine whether a fabric is a light-transmissive fabric using the four types of texture images.

(7) In the method of creating proof image data according to the aspect, the transmission characteristic information acquired in (d) may include an on-thread texture threshold for determining that each pixel representing the texture-added proof image data corresponds to a portion on a weaving thread of the print fabric, a gap texture threshold for determining that each pixel corresponds to a gap between weaving threads of the print fabric, an on-thread background reference rate that is a rate of reference to a backing color in the pixel corresponding to the portion on the weaving thread, a gap background reference rate that is a rate of reference to the backing color in the pixel corresponding to the gap, and a black area background reference rate used for adjusting a background reference rate in a pixel of a black area.

According to the configuration, the on-thread texture threshold, the gap texture threshold, the on-thread background reference rate, the gap background reference rate, and the black area background reference rate as the transmission characteristic information can be obtained.

(8) In the method of creating proof image data according to the aspect, in (d), the on-thread texture threshold may be calculated using a maximum lightness and a minimum lightness contained in the first lightness map and a maximum lightness and a minimum lightness contained in the second lightness map, the gap texture threshold may be calculated using a black lightness that is a lightness set for the black second backing, the on-thread background reference rate may be calculated using the black lightness, the maximum lightness contained in the first lightness map, and the maximum lightness contained in the second lightness map, the gap background reference rate may be calculated using the black lightness, the maximum lightness contained in the first lightness map, and the minimum lightness contained in the second lightness map, and the black area background reference rate may be calculated using an average of the lightness contained in the third lightness map and an average of the lightness contained in the fourth lightness map.

According to the configuration, it is possible to easily obtain the on-thread texture threshold, the gap texture threshold, the on-thread background reference rate, the gap background reference rate, and the black area background reference rate as the transmission characteristic information using the four lightness maps.

(9) In the method of creating proof image data according to the aspect, in (e), as texture information used for representing unevenness of the print fabric in the texture-added proof image data, any one of the first lightness map, the second lightness map, the third lightness map, and the fourth lightness map may be selected according to the transmission characteristic of the print fabric and the evenness of dye of the ink.

According to the configuration, the unevenness of the print fabric can be represented in the texture-added proof image using any one of the four lightness maps.

(10) According to a second aspect of the present disclosure, a proof image generation device is provided. The proof image generation device includes a basic proof image acquisition unit that acquires basic proof image data for reproducing, by a proof output device, a color of a print fabric obtained by printing an image on a fabric using a printing machine, a texture information acquisition unit that acquires four types of texture information based on four types of texture images including (i) an image obtained by imaging a non-print area with no image printed thereon using ink of a fabric for texture acquisition with a first backing as a background, (ii) an image obtained by imaging the non-print area of the fabric for texture acquisition with a second backing having a color different from the first backing as a background, (iii) an image obtained by imaging a print area with an image printed thereon using the ink of the fabric for texture acquisition with the first backing as a background, and (iv) an image obtained by imaging the print area of the fabric for texture acquisition with the second backing as a background, an evenness of dye characteristic acquisition unit that acquires evenness of dye characteristic information indicating evenness of dye of the ink in the fabric for texture acquisition using the four types of texture information, a transmission characteristic acquisition unit that acquires transmission characteristic information indicating the transmission characteristics of the fabric for texture acquisition using the four types of texture information, and a texture-added proof image data creation unit that creates texture-added proof image data by applying texture addition processing using the evenness of dye characteristic information and the transmission characteristic information to the basic proof image data.

According to the configuration, the reproducibility of the texture of the medium can be improved in the texture-added proof image data to which the texture is added in the proof image representing the medium through which the background is seen through.

(11) According to a third aspect of the present disclosure, a non-transitory computer-readable storage medium storing a program is provided. The program is a program for creating texture-added proof image data causing a computer to implement a function of acquiring basic proof image data for reproducing, by a proof output device, a color distribution of a basic printed matter formed by applying a basic backing to a print fabric obtained by printing an image on a fabric using a printing machine, a function of acquiring four types of texture information based on four types of texture images including (i) an image obtained by imaging a non-print area with no image printed thereon using ink of a fabric for texture acquisition with a first backing as a background, (ii) an image obtained by imaging the non-print area of the fabric for texture acquisition with a second backing having a color different from the first backing as a background, (iii) an image obtained by imaging a print area with an image printed thereon using the ink of the fabric for texture acquisition with the first backing as a background, and (iv) an image obtained by imaging the print area of the fabric for texture acquisition with the second backing as a background, a function of acquiring evenness of dye characteristic information indicating evenness of dye of the ink in the fabric for texture acquisition using the four types of texture information, a function of acquiring transmission characteristic information indicating a degree of light transmission of the fabric for texture acquisition using the four types of texture information, and a function of creating texture-added proof image data by applying texture addition processing using the evenness of dye characteristic information and the transmission characteristic information to the basic proof image data.

According to the configuration, the reproducibility of the texture of the medium can be improved in the texture-added proof image data to which the texture is added in the proof image representing the medium through which the background is seen through.

The present disclosure can be implemented in various aspects other than the above-described aspects, and can be implemented as, for example, a computer program for implementing the function of the proof image data creation device. For example, the present disclosure can be implemented in an aspect of a non-transitory storage medium in which a computer program is recorded.

What is claimed is:

1. A method of creating proof image data comprising:
(a) acquiring basic proof image data for reproducing, by a proof output device, a color distribution of a basic printed matter formed by applying a basic backing to a print fabric obtained by printing an image on a fabric using a printing machine;
(b) acquiring four types of texture information based on four types of texture images including (i) an image obtained by imaging a non-print area with no image printed thereon using ink of a fabric for texture acquisition with a first backing as a background, (ii) an image obtained by imaging the non-print area of the fabric for texture acquisition with a second backing having a color different from the first backing as a background, (iii) an image obtained by imaging a print area with an image printed thereon using the ink of the fabric for texture acquisition with the first backing as a background, and (iv) an image obtained by imaging the print area of the fabric for texture acquisition with the second backing as a background;
(c) acquiring evenness of dye characteristic information indicating evenness of dye of the ink in the fabric for texture acquisition using the four types of texture information;
(d) acquiring transmission characteristic information indicating a degree of light transmission of the fabric for texture acquisition using the four types of texture information; and
(e) creating texture-added proof image data by applying texture addition processing using the evenness of dye characteristic information and the transmission characteristic information to the basic proof image data.

2. The method of creating proof image data according to claim 1, wherein
the first backing is white and the second backing is black, and
the four types of texture information include:
a first lightness map generated based on a first texture image obtained by imaging the non-print area with the white first backing as a background;
a second lightness map generated based on a second texture image obtained by imaging the non-print area with the black second backing as a background;
a third lightness map generated based on a third texture image obtained by imaging the print area with the white first backing as a background; and
a fourth lightness map generated based on a fourth texture image obtained by imaging the print area with the black second backing as a background.

3. The method of creating proof image data according to claim 2, wherein
a Duty value of the ink in the print area contained in the fabric for texture acquisition is set to be equal to or greater than a predetermined reference value.

4. The method of creating proof image data according to claim 3, wherein
the print area contained in the fabric for texture acquisition is an area printed in black in a device-dependent color space.

5. The method of creating proof image data according to claim 4, wherein
a color of the fabric for texture acquisition is white, and
in (c), when a variance of lightness contained in the fourth lightness map is larger than a variance of lightness contained in the first lightness map and a difference between the variance of the lightness contained in the first lightness map and the variance of the lightness contained in the fourth lightness map is larger than a predetermined value, it is determined that dyeing of the fabric for texture acquisition with the ink is uneven.

6. The method of creating proof image data according to claim 5, further comprising:
(f) determining whether the print fabric is a light-transmissive fabric using the third lightness map and the fourth lightness map when the evenness of dye characteristic information acquired in (c) indicates that the dyeing of the fabric for texture acquisition with the ink is uneven; and
(g) determining the whether fabric for texture acquisition is the light-transmissive fabric using the first lightness map and the second lightness map when the evenness of dye characteristic information acquired in (c) indicates that the dyeing of the fabric for texture acquisition with the ink is even.

7. The method of creating proof image data according to claim 6, wherein
the transmission characteristic information acquired in (d) includes:
an on-thread texture threshold for determining that each pixel representing the texture-added proof image data corresponds to a portion on a weaving thread of the print fabric;
a gap texture threshold for determining that each pixel corresponds to a gap between weaving threads of the print fabric;
an on-thread background reference rate that is a rate of reference to a backing color in the pixel corresponding to the portion on the weaving thread;
a gap background reference rate that is a rate of reference to the backing color in the pixel corresponding to the gap; and
a black area background reference rate used for adjusting a background reference rate in a pixel of a black area.

8. The method of creating proof image data according to claim 7, wherein
in (d),
the on-thread texture threshold is calculated using a maximum lightness and a minimum lightness contained in the first lightness map and a maximum lightness and a minimum lightness contained in the second lightness map,
the gap texture threshold is calculated using a black lightness that is a lightness set for the black second backing,
the on-thread background reference rate is calculated using the black lightness, the maximum lightness contained in the first lightness map, and the maximum lightness contained in the second lightness map,
the gap background reference rate is calculated using the black lightness, the maximum lightness contained in the first lightness map, and the minimum lightness contained in the second lightness map, and
the black area background reference rate is calculated using an average of the lightness contained in the third lightness map and an average of the lightness contained in the fourth lightness map.

9. The method of creating proof image data according to claim 8, wherein
in (e), as texture information used for representing unevenness of the print fabric in the texture-added proof image data, any one of the first lightness map, the second lightness map, the third lightness map, and the fourth lightness map is selected according to the transmission characteristic of the print fabric and the evenness of dye of the ink.

10. A proof image generation device comprising:
a basic proof image acquisition unit that acquires basic proof image data for reproducing, by a proof output device, a color distribution of a basic printed matter formed by applying a basic backing to a print fabric obtained by printing an image on a fabric using a printing machine;
a texture information acquisition unit that acquires four types of texture information based on four types of texture images including (i) an image obtained by imaging a non-print area with no image printed thereon using ink of a fabric for texture acquisition with a first backing as a background, (ii) an image obtained by imaging the non-print area of the fabric for texture acquisition with a second backing having a color different from the first backing as a background, (iii) an image obtained by imaging a print area with an image printed thereon using the ink of the fabric for texture acquisition with the first backing as a background, and (iv) an image obtained by imaging the print area of the fabric for texture acquisition with the second backing as a background;
an evenness of dye characteristic acquisition unit that acquires evenness of dye characteristic information indicating evenness of dye of the ink in the fabric for texture acquisition using the four types of texture information;
a transmission characteristic acquisition unit that acquires transmission characteristic information indicating a degree of light transmission of the fabric for texture acquisition using the four types of texture information; and
a texture-added proof image data creation unit that creates texture-added proof image data by applying texture addition processing using the evenness of dye characteristic information and the transmission characteristic information to the basic proof image data.

11. A non-transitory computer-readable storage medium storing a program, the program for creating texture-added proof image data causing a computer to implement:
a function of acquiring basic proof image data for reproducing, by a proof output device, a color distribution of a basic printed matter formed by applying a basic backing to a print fabric obtained by printing an image on a fabric using a printing machine;
a function of acquiring four types of texture information based on four types of texture images including (i) an image obtained by imaging a non-print area with no image printed thereon using ink of a fabric for texture acquisition with a first backing as a background, (ii) an image obtained by imaging the non-print area of the fabric for texture acquisition with a second backing having a color different from the first backing as a background, (iii) an image obtained by imaging a print area with an image printed thereon using the ink of the fabric for texture acquisition with the first backing as a background, and (iv) an image obtained by imaging the print area of the fabric for texture acquisition with the second backing as a background;
a function of acquiring evenness of dye characteristic information indicating evenness of dye of the ink in the fabric for texture acquisition using the four types of texture information;
a function of acquiring transmission characteristic information indicating a degree of light transmission of the fabric for texture acquisition using the four types of texture information; and
a function of creating texture-added proof image data by applying texture addition processing using the evenness of dye characteristic information and the transmission characteristic information to the basic proof image data.
